(19) United States
(12) Patent Application Publication
(10) Pub. No.: US 2014/0282012 A1
(43) Pub. Date: Sep. 18, 2014

(54) METHOD AND SYSTEM FOR MAKING STORYFORMING CHOICES BASED ON ASSOCIATED OBJECTS

(71) Applicant: WRITE BROTHERS, INC., Burbank, CA (US)

(72) Inventors: Stephen Michael GREENFIELD, Glendale, CA (US); Chris Neal HUNTLEY, Altadena, CA (US)

(73) Assignee: WRITE BROTHERS, INC., Burbank, CA (US)

(21) Appl. No.: 14/214,084

(22) Filed: Mar. 14, 2014

Related U.S. Application Data
(60) Provisional application No. 61/794,460, filed on Mar. 15, 2013.

(51) Int. Cl. G06F 3/0484; G06F 3/0482

(52) U.S. Cl. CPC G06F 3/04842; G06F 3/0482
USPC 715/731

(57) ABSTRACT

The system relates to the process of associating textual or media Objects with the structural and dynamic choices of a narrative model and the application of those Objects to build an underlying narrative.

This patent application claims priority to U.S. Provisional Patent Application No. 61/794,460 filed on Mar. 15, 2013, which is incorporated by reference herein in its entirety.

### TECHNICAL FIELD

The system relates to the process of associating textual, media, or programmatic objects with the structural and dynamic choices of a narrative model and the application of those objects to build an underlying narrative.

### BACKGROUND OF THE SYSTEM

U.S. Pat. No. 5,734,916 A (incorporated by reference herein in its entirety) discloses a model of narrative that separates the expression of an idea—its subject matter—from the structural and dynamic choices that create the underlying story. This expression is referred to as its “Storytelling”:
“Storytelling is an expression of an arrangement of story structure and dynamics that creates the dynamics of the story. When storytelling is combined with the structure of the story, the nature of the problem becomes too nonspecific and the number of possible solutions becomes infinite. These combinations create the enormous variety seen in stories, but also make the task of discovering the underlying patterns very difficult.”

However, this separation of storytelling from structural and dynamic choices also makes the process of “Storyforming”—creating the underlying narrative—more difficult. Storyform is the unique arrangement of structure and dynamics that creates the dramatics of each story. Presently, when Storyforming, a user must navigate choices devoid of subject matter, using a specific terminology that requires considerable knowledge, skill, and experience to apply correctly. For example, a user might need to select the concept of “Delay”, or “Choice”, or one or more of hundreds of unique terms.

Although each term has a definition that helps clarify its conceptual meaning, a definition provides little assistance in the daunting task of connecting those concepts to a narrative being analyzed or constructed.

While each term has a definition, no method existed to pre-associate storytelling text with the structural or dynamic terminology. Users of this narrative model could not create, search, or apply pre-associated storytelling objects.

### SUMMARY

The system comprises a computer-based system for associating Objects with the specific terminology used by structural and dynamic choices (Storyforming Terms) then selecting those associated objects to build a narrative. For example, the structural concept of “Delay” might be associated with the descriptive phrase objects “Getting a stay of execution,” “Having a layover,” and “Establishing a moratorium.” The association of these Objects with a Storyforming Term is referred to as a “Gist”. Each of the Storyforming Terms in the model might be individually associated with an unlimited number of Gists.

In one or more embodiments, the Object may be a descriptive textual phrase, an image, a video clip, an audio clip, a document, a selection from a document, or a programmatic function.

In one or more embodiments, the user may create Gists by creating their own Object then associating that Object with a Storyforming Term.

In one or more embodiments, the user may create Gists by choosing a pre-existing Object then associating that Object with a Storyforming Term.

In one or more embodiments, the user may create Gists by first selecting a Storyforming Term then creating their own associated Object.

In one or more embodiments, the user may create Gists by first selecting a Storyforming Term then choosing a pre-existing Object to associate.

In one or more embodiments, the user may invoke commands that create Gists by algorithmically determining both the Storyforming Term and the Object and making the association between them.

In one or more embodiments, the system may display lists of Gists from pre-existing Collections.

In one or more embodiments, a narrative can be built by selecting Gists instead of the Storyforming Term. Because of the pre-existing association, the process of selecting the Gist results in the selection of the Storyforming Term in the contextually relevant Appreciation and thus the underlying structural or dynamic concept.

In one or more embodiments, a Gist may also store and represent an “Appreciation”. This combination of Object, Storyforming Term, and Appreciation is referred to as a Super Gist.

In one or more embodiments, a Super Gist may provide the Appreciation used in the process of applying the associated Storyforming Term.

In one or more embodiments, additional keywords and metadata may be associated with a Gist.

In one or more embodiments, the user may provide search parameters to a filter to create a subset of relevant Gists.

In one or more embodiments, the user builds a narrative by manually selecting Gists from a list.

In one or more embodiments, the user builds a narrative by invoking commands that result in the algorithmic selection of Gists. An example might be a feature to randomly select a Gist from a collection of Gists. Another example might be the algorithmic analysis of text to create and apply Gists or Super Gists.

### BRIEF DESCRIPTION OF THE DRAWINGS

FIG. 1 is a flow chart of the process of Creating a Gist in one embodiment.

FIG. 2 is a flow chart of the process of Applying a Gist in one embodiment.

FIG. 3 illustrates an example computer embodiment.

### DETAILED DESCRIPTION OF THE INVENTION

A method and apparatus for associating Objects with the specific terminology used by the structural and dynamic choices disclosed in the narrative model of U.S. Pat. No. 5,734,916 A (March 1998), and selecting those associated Objects to build a narrative. As described in that patent:

“To perceive the essence of the “big picture”, one must separate Storyform from Storytelling. Storyform is the unique arrangement of structure and dynamics that creates the dramatics of each story. Storytelling is the way that arrangement is illustrated. As an example, we might imagine an author wishing to communicate the abandonment of morality in favor of self-interest. To illustrate this concept the author might describe someone taking candy from a baby or drinking the last water in a lost desert patrol. The essential concept of morality vs. self-interest is part of the storyform. Either of these scenarios specifically used to make the point would be the storytelling.”

Thus someone constructing a story would use structural elements for Storyforming and would select or create dynamic Objects (taking candy from a baby) that represent a structural element (abandonment of morality) to accomplish Storytelling.

The process of building a narrative is simplified and sped up using a process where the user searches and selects from collections of pre-existing textual phrases or other Objects (such as video, audio, images, documents, document selections, or programming functions) that have been pre-associated with the structural or dynamic terminology. Note that these Object types are by way of example only, and the present invention is not limited to these object types.

The terminology used by structural and dynamic choices is referred to as “Storyforming Terms.” The “Objects” that may be associated with Storyforming Terms include, but are not limited to, textual short phrases, audio clips, video clips, images, documents, selections from documents, and programming functions. The association of an Object to a Storyforming Term is known herein as a “Gist.” Gists may already exist in stored “Collections” or may be manually created at will by the user or automatically by a user-invoked algorithm. Gists may be applied in the context of an “Appreciation”, which is one of dozens of commonly shared dramatic concepts that are present in a story and is defined more fully in incorporated U.S. Pat. No. 5,734,916. The application of a Gist to an Appreciation results in applying the associated Storyforming Term to the narrative model. Gists may also be further pre-associated with an Appreciation, in a concept referred to as a “Super Gist.” In this case, application of the Super Gist serves to both pick the Appreciation and apply the Storyforming Term in a single operation.

By using Gists, a Storytelling operation is streamlined because the user can select an Object that matches a Storyforming Term with more certainty. By selecting one of a plurality of existing Objects that are associated with a Storyforming Term via a Gist, the user can be certain that the Storyform is served properly. If the user desires to create his own Object to represent the Storyforming Term, the Gist can provide examples that increase the likelihood that the new Object is an appropriate one that illustrates the Storyforming Term.

FIG. 1 describes the process of creating Gists. The creation process begins at step 101 with the selection of the type of the Object to create. This Object may be, but is not limited to, a short textual phrase, an audio clip, a video clip, an image, a document, a selection from a document, or a programming function.

At decision block 102 we determine if the Object already exists or is to be created. By way of example, if the Object exists at step 102, the user may wish to select and import an existing object 103 (e.g. audio clip). If the Object does not exist at step 102, the user may wish to create a new object at step 104 (e.g. record a new audio clip). In the example of a short textual phrase, the step Create Object 104 would mean entering the text of the phrase.

To create a Gist we need to associate the Object with a Storyforming Term (i.e. structural element). At step 105 we determine if we already know the Storyforming Term. For example, the Storyforming Term may be known due to an existing state in the creation process, such as the context of a question the user is answering or may have previously answered. If we do not know the Storyforming Term at step 105, the user must select one at step 106.

After selection of a Storyforming term at step 106, or if the Storyforming term exists at step 105, the user may choose at step 107 to add optional and/or additional information to the Gist. If so, such information may include keywords or other metadata at step 108 that would assist in finding, using, and understanding the Gist.

It should be apparent to one skilled in the art that the order of adding optional information could precede step 105 or follow step 109.

After step 108, or if the user does not wish to modify the Object at step 107, the system proceeds to step 109 and asks the user to confirm creation of the Gist. If the user confirms the creation of the Gist 109 then the Gist is recorded 110 in computer memory. Otherwise, the Gist is not created.

The process of applying a Gist is described in the flow diagram of FIG. 2. In one embodiment, the user desires to provide an Object to represent a Storyforming term that the user has selected or that is a consequence of other Storyforming decisions the user has made. The user is presented with a list of Gist choices at step 201. These choices are all the Objects that have been associated with the Storyform term via Gist creation (such as described in FIG. 1). It should be noted that it is possible for an Object to be in more than one Gist, depending on the Object. In the present invention these choices may be displayed as a list, but other methods of presentation, such as menus, or auto-completion, may be used.

In one embodiment, all Objects that are associated with a Storyforming term via a Gist are presented to the user. In another embodiment, there may be filtering that deselects certain Gist Objects that would not be appropriate based on other choices the user has made. This filtering may be accomplished by use of the metadata included with an Object during Gist creation or at other times. In another embodiment, Objects that are presented to the user may be ordered based on Storyforming rules or based on previous choices made by the user.

The list of available Gists may be subjected to another type of filter, which the user may choose to adjust at decision step 202. Examples of filters that may be applied at step 203 include filtering by Gist name or text, Collection, associated Storyforming Term, metadata, keyword, and attributes. Examples of attributes may include automatically generated data such as Gist author, creation date, and count of times the Gist has been used. This may help narrow down a large list of Objects to a more manageable size for selection by the user.

The user may choose at step 204 to use one of the listed Gists by selecting it at step 206, or may choose to create a new Gist 205. Choosing to create a new Gist 205 follows the process of FIG. 1, for example.

The selected Gist 206 or the created Gist 205 is then used to set the appropriate contextually relevant Appreciation in the narrative model at step 207 by applying the Associated Storyforming Term of FIGS. 1 105 and 106 that was recorded in 110.

In the example of a Super Gist, the relevant Appreciation is also provided by the selected Gist 206 or the created Gist 205.

### Embodiment of Computer Execution Environment (Hardware)

An embodiment of the system can be implemented as computer software in the form of computer readable program code executed in a general purpose computing environment such as environment 300 illustrated in FIG. 3, or in the form of bytecode class files executable within a Java.™. run time environment running in such an environment, or in the form of bytecodes running on a processor (or devices enabled to process bytecodes) existing in a distributed environment (e.g., one or more processors on a network). A keyboard 310 and mouse 311 are coupled to a system bus 318. The keyboard and mouse are for introducing user input to the computer system and communicating that user input to central processing unit (CPU 313. Other suitable input devices may be used in addition to, or in place of, the mouse 311 and keyboard 310. I/O (input/output) unit 319 coupled to bi-directional system bus 318 represents such I/O elements as a printer, A/V (audio/video) I/O, etc.

Computer 301 may be a laptop, desktop, tablet, smart-phone, or other processing device and may include a communication interface 320 coupled to bus 318. Communication interface 320 provides a two-way data communication coupling via a network link 321 to a local network 322. For example, if communication interface 320 is an integrated services digital network (ISDN) card or a modem, communication interface 320 provides a data communication connection to the corresponding type of telephone line, which comprises part of network link 321. If communication interface 320 is a local area network (LAN) card, communication interface 320 provides a data communication connection via network link 321 to a compatible LAN. Wireless links are also possible. In any such implementation, communication interface 320 sends and receives electrical, electromagnetic or optical signals which carry digital data streams representing various types of information.

Network link 321 typically provides data communication through one or more networks to other data devices. For example, network link 321 may provide a connection through local network 322 to local server computer 323 or to data equipment operated by ISP 324. ISP 324 in turn provides data communication services through the world wide packet data communication network now commonly referred to as the “Internet” 323 Local network 322 and Internet 323 both use electrical, electromagnetic or optical signals which carry digital data streams. The signals through the various networks and the signals on network link 321 and through communication interface 320, which carry the digital data to and from computer 300, are exemplary forms of carrier waves transporting the information.

Processor 313 may reside wholly on client computer 301 or wholly on server 323 or processor 313 may have its computational power distributed between computer 301 and server 323. Server 323 symbolically is represented in FIG. 3 as one unit, but server 323 can also be distributed between multiple “tiers”. In one embodiment, server 323 comprises a middle and back tier where application logic executes in the middle tier and persistent data is obtained in the back tier. In the case where processor 313 resides wholly on server 323, the results of the computations performed by processor 313 are transmitted to computer 301 via Internet 323, Internet Service Provider (ISP) 324, local network 322 and communication interface 320. In this way, computer 301 is able to display the results of the computation to a user in the form of output.

Computer 301 includes a video memory 314, main memory 315 and mass storage 312, all coupled to bi-directional system bus 318 along with keyboard 310, mouse 311 and processor 313.

As with processor 313, in various computing environments, main memory 315 and mass storage 312, can reside wholly on server 323 or computer 301, or they may be distributed between the two. Examples of systems where processor 313, main memory 315, and mass storage 312 are distributed between computer 301 and server 323 include thin-client computing architectures and other personal digital assistants, Internet ready cellular phones and other Internet computing devices, and in platform independent computing environments,

The mass storage 312 may include both fixed and removable media, such as magnetic, optical or magnetic optical storage systems or any other available mass storage technology. The mass storage may be implemented as a RAID array or any other suitable storage means. Bus 318 may contain, for example, thirty-two address lines for addressing video memory 314 or main memory 315. The system bus 318 also includes, for example, a 32-bit data bus for transferring data between and among the components, such as processor 313, main memory 315, video memory 314 and mass storage 312. Alternatively, multiplex data/address lines may be used instead of separate data and address lines.

In one embodiment of the invention, the processor 313 is a microprocessor such as manufactured by Intel, AMD, Sun, etc. However, any other suitable microprocessor or microcomputer may be utilized, including a cloud computing solution. Main memory 315 is comprised of dynamic random access memory (DRAM). Video memory 314 is a dual-ported video random access memory. One port of the video memory 314 is coupled to video amplifier 319. The video amplifier 319 is used to drive the cathode ray tube (CRT) raster monitor 317. Video amplifier 319 is well known in the art and may be implemented by any suitable apparatus. This circuitry converts pixel data stored in video memory 314 to a raster signal suitable for use by monitor 317. Monitor 317 is a type of monitor suitable for displaying graphic images.

Computer 301 can send messages and receive data, including program code, through the network(s), network link 321, and communication interface 320. In the Internet example, remote server computer 323 might transmit a requested code for an application program through Internet 323, ISP 324, local network 322 and communication interface 320. The received code maybe executed by processor 313 as it is received, and/or stored in mass storage 312, or other non-volatile storage for later execution. The storage may be local or cloud storage. In this manner, computer 300 may obtain application code in the form of a carrier wave. Alternatively, remote server computer 323 may execute applications using processor 313, and utilize mass storage 312, and/or video memory 315. The results of the execution at server 323 are then transmitted through Internet 323, ISP 324, local network 322 and communication interface 320. In this example, computer 301 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

Although the invention has been described with respect to certain example embodiments, it will be apparent to those skilled in the art that the present invention is not limited to these specific embodiments. For example, the sample embodiments describe the invention as being operated interactively by a user, however the invention can also be operated algorithmically without user interaction.

What is claimed is:

1. A method for associating an Object with a Storyforming Term comprising:
selecting at least one Object, where an Object represents an expression of a structural element of a story;
selecting at least one Storyforming Term that represents the structural element;
creating an association between the Object and the Storyforming Term where the association comprises a Gist.

2. The method of claim 1 where the Object may be a textual phrase, an audio clip, a video clip, an image, a document, a selection from a document, or a programming function.

3. The method of claim 1 where the Storyforming Term is determined by having a user manually select the Storyforming Term.

4. The method of claim 1 where the Storyforming Term is automatically selected using algorithmic means.

5. The method of claim 1 where the Object is created by algorithmic means.

6. The method of claim 1 where optional metadata is associated with the Gist.

7. The method of claim 1 where the Storyforming Term of claim 1 is determined first, and the type of the Object is determined second.

8. The method of claim 1 where the Object is selected from a list of existing Objects.

9. The method of claim 1 where the Gist is further associated with an Appreciation.

10. A method for adding an Object to a Storyform comprising:
identifying a Storyforming Term for which an Object is required;
presenting a plurality of Gists to a user, wherein each of the Gists comprises one of a plurality of Objects that are associated with the Storyforming Term;
selecting at least one of the plurality of Gists and adding it to the Storyform.

11. The method of claim 10 where the user manually selects the Gist from a list.

12. The method of claim 10 where the Gist is automatically chosen using algorithmic means.

13. The method of claim 11 where the user applies a filter to define the list Gists.

14. The method of claim 13 where the filter may be at least one of a textual name, a collection of existent Gists, a storyforming term, keywords, attributes, and metadata.
